(19) United States
(12) Patent Application Publication
(10) Pub. No.: US 2014/0280254 A1
(43) Pub. Date: Sep. 18, 2014

(54) Data Acquisition System

(71) Applicant: FEICHTNER DATA GROUP, INC., Spokane, WA (US)

(72) Inventors: Mark Eugene Feichtner, Spokane, WA (US); Windy Ellen Young, Spokane, WA (US); Brian Joseph Zier, Spokane, WA (US); Matthew Jeffery Laukala, Spokane, WA (US); Gerry Dean Crooks, Spokane, WA (US); Robert Earl Moss, Spokane, WA (US)

(73) Assignee: FEICHTNER DATA GROUP, INC., Spokane, WA (US)

(21) Appl. No.: 13/843,734

(22) Filed: Mar. 15, 2013

(51) Int. Cl. G06F 17/30

(52) U.S. Cl. CPC G06F 17/30306
USPC 707/755

(57) ABSTRACT

A data acquisition system can receive a plurality of files from a plurality of sources and can automate selection of a suitable application for accessing each file and determination of a suitable pattern template for recognizing and extracting data from a respective file. The data acquisition system can store the extracted data in a customized data structure that can be specified for each source and/or each type of data. The data acquisition system further can provide one or more user interfaces that can enable a user to upload, create or define a pattern template for a file and/or document.

### BACKGROUND

With the ever-growing amount of data nowadays, business entities (e.g., utilities, restaurants, property management companies, other companies, etc.) are facing increasing difficulties in managing and mining data to obtain valuable information. Furthermore, prior to managing and mining the data, the business entities usually need to acquire the data in the first place, and then store the data in a specified form or format for subsequent use. The business entities, however, typically receive this data in different forms.

Today, business entities generally employ humans to input the data manually into their computer systems. This is not only time-consuming, but also expensive. Although certain data acquisition systems have been proposed, these data acquisition systems are minimally automated and often require human intervention. Moreover, these data acquisition systems usually break down or fail to function upon receiving data in an unexpected format.

### SUMMARY

This application describes example embodiments of data acquisition. In some embodiments, a data acquisition system can receive a file. The data acquisition system can determine a file type of the file and select an application to access the file based on the determined file type. In at least one embodiment, the data acquisition system can select the application from a plurality of applications that are configured to access files of different file types. In response to accessing the file, the data acquisition system can recognize data in the file based on a pattern template. In some embodiments, the pattern template can specify, for example, one or more positions of the data expected to be found in the file within a predetermined threshold of error and/or one or more content items expected to be found in the file. The one or more content items may include, but are not limited to, a keyword, an image, a barcode, a quick response (QR) code, etc.

This summary introduces simplified concepts of data acquisition, which are further described below in the Detailed Description. This summary is not intended to identify essential features of the claimed subject matter, nor is it intended for use in limiting the scope of the claimed subject matter.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items.

FIG. 1 illustrates an example environment including an example data acquisition system.

FIG. 2 illustrates an example device including a data acquisition system consistent with FIG. 1 in more detail.

FIG. 3 illustrates a process flow of an example data acquisition system consistent with the preceding figures.

FIG. 4 illustrates a process flow of an example data acquisition system consistent with the preceding figures.

FIG. 5 illustrates a first example process of data acquisition.

FIG. 6 illustrates a second example process of data acquisition.

FIGS. 7A and 7B illustrate aspects of the process of data acquisition as described regarding FIG. 6.

FIG. 8 illustrates a screen rendering of an example Graphical User Interface (GUI) on an electronic computing device, which allows a user of the device to initiate the selection of a vendor associated with a file and/or document such as an invoice.

FIGS. 9 and 10 illustrate a screen rendering of an example data definitions tab after a vendor has been selected. FIG. 9 illustrates the selection of data definitions. Meanwhile, FIG. 10 illustrates a display of selected data elements.

FIG. 11 illustrates a screen rendering of an example Graphical User Interface on an electronic computing device, which allows a user of the device to create a header of a pattern template, the pattern template associated with a vendor.

FIG. 12 illustrates an example Graphical User Interface that displays an interactive invoice, after creating a header of a pattern template, the pattern template associated with a vendor.

FIG. 13 illustrates a screen rendering of an example Graphical User Interface on an electronic computing device, which allows a user of the device to create a line item of a pattern template, the line item associated with a header, and the pattern template associated with a vendor.

FIG. 14 illustrates a screen rendering of an example Graphical User Interface on an electronic computing device, which allows a user of the device to create a detail of a pattern template, the detail associated with a line item, and the pattern template associated with a vendor.

FIGS. 15, 16, 17, and 18 illustrate an example Graphical User Interface that provides an easy-to-use interactive interface to initiate or to represent data translation.

### DETAILED DESCRIPTION

### Overview

As noted above, business entities face difficulties in effectively gathering data, and hence are limited in their abilities to manage and mine the data for any specified business purpose. This is especially true if the business entities receive the data in different forms. For example, some data may be printed on papers (such as paper invoices, etc.) while other data may be received in an electronic form. Even in an electronic form, data may also come in different formats, e.g., an image file format, a portable data format, a scanned format, etc. Worse still, templates that are used for formatting and/or describing the data may be different across different vendors, for example, and may change over the time. Although the business entities can hire humans to input the data manually into their computer systems, this approach is expensive and time-consuming. Furthermore, existing data acquisition systems fail to operate substantially automatically and require a lot of human intervention, thus incurring expensive costs.

This disclosure describes a data acquisition system, which minimizes human intervention and automates acquisition of data from one or more files of an entity (e.g., a vendor, other types of sources could include a service provider, a retailer, a wholesaler, a utility, etc., hereinafter termed a “vendor”). In an event that human intervention or input is needed, the data acquisition system forwards a request including a reason for human input and/or a suggestion for resolving an issue that causes the request.

In at least one implementation, the data acquisition system can receive a file from a vendor. The file can be related to an invoice, a payment receipt, a purchase order, a utility bill, etc. The data acquisition system can receive the file in an electronic form or a paper form. In an event that the file is received in a paper form, the data acquisition system can further include a scanning functionality to convert the file to an electronic form. In response to receiving the file, the data acquisition system can determine a file type (or format) of the file. The data acquisition system can determine the file type of the file based on an extension of a filename of the file, for example.

After determining the file type of the file, the data acquisition system can select a suitable application that can access or read the file of that particular file type. In at least one implementation, the data acquisition system can include a plurality of applications with each application being able to access or read files of one or more different file types. Additionally or alternatively, the data acquisition system can be associated with one or more applications that are able to access or read the file for the data acquisition system. In some implementations, if more than one application is able to access or read the file of that particular file type, the data acquisition system can select an application that is default (e.g., by a user of the data acquisition system or the acquisition system itself) for that file type.

Additionally or alternatively, the data acquisition system can identify or determine a source (e.g., a vendor) of the file, i.e., which source the file is associated with or received from. In at least one implementation, the data acquisition system can identify or determine the source of that file based on, for example, a human input. Additionally or alternatively, the data acquisition system can identify or determine the source of that file based on accessing data included in the file. For example, the data of the file can include identification information of the source.

Upon identifying or determining the source of this file, the data acquisition system can attempt to determine a pattern template for recognizing and/or matching data of the file. In at least one embodiment, the data acquisition system may include one or more pattern templates for the source, and may apply the one or more pattern templates to the file one by one. For example, the data acquisition system may apply the most recently used pattern template for that source to the file. In some embodiments, if the data acquisition system fails to recognize the data of the file using the most recently used pattern template, the data acquisition system may select another pattern template (if another pattern template exists for the source). Additionally, the data acquisition system may report an issue to a relevant entity (such as a human operator, a computer system that has been configured or automated to handle this type of issue, etc.).

In some embodiments, the data acquisition system may validate the data of the file based on one or more validation rules. The one or more validation rules may include, for example, data format and/or data type for the data of the file. If the data acquisition system successfully validates the data, the data acquisition system may extract one or more pieces of the data from the file and store the one or more extracted pieces of the data in a customized data structure. Depending on which source and/or which type (text, image, barcode, etc.) of content of the extracted pieces, the data acquisition system may store the extracted pieces differently for different sources and/or different types of content. In some embodiments, the data acquisition system may store the data structure locally therein or remotely in a network device, for example. Additionally or alternatively, the data acquisition system may store the data structure in a removable or portable storage device so that the user may manipulate the data via a computing device, for example.

The described system minimizes human intervention or input and intelligently selects a pattern template suitable for parsing and extracting data from a file associated with a source (such as a vendor). The system therefore saves a business entity from manually inputting data of a plurality of different files into a respective computer system, thus saving human resources and reducing operating cost.

In the examples described herein, the data acquisition system receives a file, determines a file type of the file, selects an application for accessing data of the file, identifies a source associated with the file, parses, extracts, and validates data from the file using one or more pattern templates, and notifies a relevant user and/or operator to resolve issues. However, in other embodiments, these functions can be performed by multiple separate systems or services. For example, in at least one embodiment, an input service can receive a file, determine a file type of the file and select an application for accessing data of the file, while a separate service can identify a source that is associated with the file. An extraction service can parse, extract, and validate data of the file, and yet another service can notify a relevant user and/or operator to resolve issues related to data acquisition.

Furthermore, although in the examples described herein, the data acquisition system can be implemented as an application, in other embodiments, the data acquisition system can be implemented as a service provided in a server over a network. Furthermore, in some embodiments, the data acquisition system can be implemented as a background or auxiliary process or application providing support to a data management or mining application or system. Additionally or alternatively, in some embodiments, the data acquisition system can be one or more services provided by one or more servers in a network or a cloud service provided in a cloud computing architecture.

The application describes multiple and varied implementations and embodiments. The following section describes an example environment that is suitable for practicing various implementations. Next, the application describes example systems, devices, and processes for implementing a data acquisition system.

### Illustrative Environment

The environment described below constitutes but one example and is not intended to limit the claims to any one particular operating environment. Other environments can be used without departing from the spirit and scope of the claimed subject matter. FIG. 1 illustrates an illustrative environment 100 that implements a data acquisition system 102. In this example, the data acquisition system 102 is described to be an individual or stand-alone system. In some embodiments, the data acquisition system 102 can be included in a client device 104. Furthermore, in some embodiments, functions of the data acquisition system 102 can be included and distributed among a plurality of computing devices. For example, the functions of the data acquisition system 102 can be included and distributed among the client device 104 and/or one or more servers 106A over a network 108. The client device 104 and the one or more servers 106A can communicate data with one another through the network 108. Furthermore, in some embodiments, the data acquisition system 102 can be included in one or more third-party servers, e.g., other servers 106B, which can or cannot be a part of a cloud computing system or architecture.

In at least one embodiment, the client device 104 can be implemented as any of a variety of computing devices 104A-104E. By way of example and not limitation, the client device 104 can include a mainframe computer, a workstation, a server, a notebook or portable computer), etc. or a combination thereof. Additionally or alternatively, the client device 102 can include, for example, a handheld device, a netbook, an Internet appliance, a tablet or slate computer, a mobile device (e.g., a mobile phone, a personal digital assistant, a smart phone, etc.), etc. or a combination thereof.

The network 108 can be a wireless or a wired network, or a combination thereof. The network 108 can be a collection of individual networks interconnected with each other and functioning as a single large network (e.g., the Internet or an intranet). Examples of such individual networks include, but are not limited to, telephone networks, cable networks, Local Area Networks (LANs), Wide Area Networks (WANs), and Metropolitan Area Networks (MANs), Wi-Fi networks, WiMax networks, satellite networks, mobile communications networks (e.g., 3G, 4G, and so forth), or any combination thereof. For example, the network 108 can include public networks such as the Internet, private networks such as an institutional and/or personal intranet, or some combination of private and public networks.

The network 108 can utilize communications protocols, including packet-based and/or datagram-based protocols such as internet protocol (IP), transmission control protocol (TCP), user datagram protocol (UDP), or other types of protocols. Moreover, the network 108 can also include a number of devices that facilitate network communications and/or form a hardware basis for the networks, such as switches, routers, gateways, access points, firewalls, base stations, repeaters, backbone devices, and the like.

In some embodiments, the network 108 can further include devices that enable connection to a wireless network, such as a wireless access point (WAP). Embodiments support connectivity through WAPs that send and receive data over various electromagnetic frequencies (e.g., radio frequencies), including WAPs that support Institute of Electrical and Electronics Engineers (IEEE) 802.11 standards (e.g., 802.11g, 802.11n, and so forth), and other standards.

In various embodiments, client devices 104 include devices such as devices 104A-104E. Embodiments support scenarios where device(s) 104 can include one or more computing devices that operate in a cluster or other grouped configuration to share resources or for other purposes. Although illustrated as a diverse variety of device types, device(s) 104 can be other device types and are not limited to the illustrated device types. Device(s) 104 can include any type of computing device with one or multiple processor(s) 110 operably connected to a memory 112. Device(s) 104 can include but are not limited to the illustrated devices 104. For example, devices 104 can include personal computers such as, for example, desktop computers 104A, laptop computers 104B, tablet computers 104C, telecommunication devices 104D, personal digital assistants (PDAs) 104E, electronic book readers, wearable computers. Devices 104 can also include business oriented devices such as, for example, server computers 106, thin clients, terminals, and/or work stations. In some embodiments, devices 104 can include, for example, components for integration in a computing device, appliances, or another sort of device.

In some embodiments, as shown regarding device 104A, memory 112 can store instructions executable by the processor(s) 110 including one or more applications or services 114 (e.g., data acquisition or collection application, etc.) and other program data 116. Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The memory 112 can be coupled to, associated with, and/or accessible to other devices, such as network servers, routers, and/or other servers 106A and/or 106B.

In at least one embodiment, a user 118 can use the data acquisition system 102 (or use the client device 104 to remotely command the data acquisition system 102) to perform data acquisition operations. Examples of the data acquisition operations can include, but are not limited to, analyzing and extracting data of a plurality of files having different file types and/or formats, and storing the extracted data in a customized data structure or format.

In various embodiments, server(s) 106 such as servers 106A and/or 106B can host a cloud-based service. Embodiments support scenarios where server(s) 106 can include one or more computing devices that operate in a cluster or other grouped configuration to share resources, balance load, increase performance, provide fail-over support or redundancy, or for other purposes. Server(s) 106 can include any type of computing device with one or multiple processor(s) 120 operably connected to memory 122.

In some embodiments, as shown regarding server(s) 106, memory 122 can store instructions executable by the processor(s) 120 including one or more applications or services 114 (e.g., data acquisition or collection application, etc.) and other program data 116. Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

FIG. 2 illustrates the data acquisition system 102 in more detail. In at least one embodiment, the data acquisition system 102 includes, but is not limited to, one or more processors 202, a network interface 204, memory 206, and an input/output interface 208. The processor(s) 202 are configured to execute instructions received from the network interface 204, received from the input/output interface 208, and/or stored in the memory 206.

The memory 206, which in some embodiments represents memory 112 and/or memory 122, or other such memory is an example of computer-readable storage media and can include volatile memory, such as Random Access Memory (RAM) and/or non-volatile memory, such as read only memory (ROM) or flash RAM, and/or other persistent and/or auxiliary computer-readable storage media. The memory 206 is an example of computer-readable media. Computer-readable media includes at least two distinct types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes tangible and/or physical forms of media included in a device and/or hardware component that is part of a device or external to a device, including, but is not limited to, phase change memory (PRAM), static random-access memory (SRAM), dynamic random-access memory (DRAM), other types of random-access memory (RAM), read-only memory (ROM), erasable programmable read-only memory (EPROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage magnetic cards, or other magnetic storage devices or media, solid-state memory devices, storage arrays, network attached storage, storage area networks, hosted computer storage or any other storage memory, storage device, and/or storage medium or any other non-transmission medium that can be used to store and maintain information for access by a computing device. However, memory 206 and the described computer-readable storage media encompassed thereby does not include communications media consisting solely of propagated signals, per se.

In contrast, communications media can embody computer readable instructions, data structures, program modules, or other data in a modulated data signal, such as a carrier wave, or other transmission mechanism. As defined herein, computer storage media does not include communication media.

In at least one embodiment, the data acquisition system 102 can include program modules 210 and program data 212. The program modules 210 can include an input module 214, which is configured to receive inputs or instructions from the user 118. For example, the user 118 can instruct the data acquisition system 102 to collect or acquire data from a file. In some embodiments, the input module 214 can be provided (e.g., by the user 118) with an address or link indicating a location of the file to be obtained. In this case, the input module 214 can be configured to retrieve the file from the indicated location based on the provided address or link.

In response to receiving the file, the data acquisition system 102 includes a determination module 216 that determines a file type (or format) of the file. In at least one embodiment, the determination module 216 can determine the file type (or format) of the file based on an extension of a filename of the file. The file type (or format) can include, but is not limited to, a scanned file type or format, an image file type or format, etc. The image file type or format can include JPEG (Joint Photographic Experts Group), Exif (Exchangeable Image File Format), TIFF (Tagged Image File Format), RAW (Raw Image Format), GIF (Graphics Interchange Format), BMP (Bitmap), PNG (Portable Network Graphics), PPM (Portable Pixmap), PGM (Portable Graymap), PBM (Portable Bitmap), etc. Additionally or alternatively, the file type (or format) can include, a text file type or format (e.g., a Word® format, a TXT format, an RTF format, a .doc format, a .docx format, etc.), a portable file type or format such as a native PDF (Portable Document Format) file type, a PS (PostScript) file type, etc. Additionally or alternatively, the file type (or format) can include a markup language format such as a Web file format (e.g., HTTP (Hypertext Transfer Protocol), XML (Extensible Markup Language)), to name to few. Additionally or alternatively, the file type (or format) can include a delimiter-separated values (DSV) file type a comma-separated values (CSV) file type, or a tab-separated values (TSV) file type, etc. Additionally or alternatively, the file type (or format) can include a quick-response code (QR Code) or a bar code. In some embodiments, the file type (or format) can include a combination of the aforementioned file types (or formats) such as a PDF file with an embedded QR Code.

Upon determining the file type (or format) of the file, a selection module 218 can select an application for accessing or reading data included in the file. The selection module 218 can select the application from a plurality of applications. In at least one embodiment, the plurality of applications can be resided or included in the data acquisition system 102. Additionally or alternatively, the plurality of applications can be included in the client device 104 and/or the servers 106, from which the data acquisition system 102 can be able to access through the network 108, for example. In either case, the selection module 218 can select the application based on the file type of the file. For example, the selection module 218 can include a list of file types or formats with which an application can handle. Additionally, the selection module 218 can include a default application to be invoked for each specific file type or format, and can invoke a next application in an event that the default application is busy, breaks down or fails to respond within a predetermined period of time (e.g., 10 seconds, etc.).

After selecting an application that is able to access or read the file based on the file type or format, the data acquisition system 102 can identify or determine a source of the file. A source of the file can include, for example, a vendor, a supplier, a service provider, a retailer, a wholesaler, a utility service provider, etc. In some embodiments, the source of the file can include a customer associated with the file (such as one who pays an invoice), etc. In at least one embodiment, the data acquisition system 102 or an identification module 220 can have identified or known the source of the file prior to receiving the file or selecting an application for accessing or reading the file. For example, the data acquisition system 102 or an identification module 220 can receive information of the source of the file from the user 118 through a user input to the input module 214.

Additionally or alternatively, the identification module 220 can identify or determine the source of the file automatically based on identification information of the source included in the file. For example, the file can include contact information (such as name, address, telephone number, an account number, etc.) of the source, a trademark or logo associated with the source, a data format or structure of the file that is specified for the source, etc. The identification module 220 can access the data of the file (through the selected application, for example), and identify or determine the source of the file based on one or more above pieces of information. In an event that the identification module 220 cannot identify or determine the source of the file, the identification module 220 can notify the user 118 or a relevant entity (e.g., a human operator or a computer module operator) that is responsible for identifying or determining the source of a file through an output module 222. The identification module 220 can then obtain information of the source from the user 118 or the relevant user and/or operator through the input module 214.

In at least one embodiment, the data acquisition module 102 can include a matching module 224. The matching module 224 can attempt to obtain header information of the file by matching a header format (or pattern template) to the data of the file. In this example, the header information refers to one or more pieces of information included in the file that represent or characterize a file or a data template of the source. In at least one embodiment, the data acquisition system 102 can determine or know this header information associated with the source in advance through human input or intervention, for example, from the user 118 or a relevant user and/or operator responsible for creating or revising header formats (or pattern templates).

Additionally or alternatively, in some embodiments, the data acquisition system 102 can automatically determine or set the one or more pieces of the header information. For example, the matching module 224 can automatically determine or set the one or more pieces of the header information by analyzing a plurality of files (having a same or similar data format) from the source. For example, the matching module 224 can perform object recognition (such as character, text and/or image recognition, etc.) on these files to analyze text, image and/or data structure, etc., included in these files. The matching module 224 can then determine one or more pieces of information that consistently appear across these different files and/or consistently located at same positions across these different files. The matching module 224 can define these determined pieces of information as header information. Furthermore, the matching module 224 can define respective positions and/or keywords of the information as a header format (or pattern template) of the source.

Regardless of how header information and/or header format for the source is/are determined, the matching module 224 can attempt to match a header format to the data of the file. In at least one embodiment, the header format can include one or more (relative or absolute) positions of data expected to be found in a file within a predetermined threshold of error, one or more content items expected to be found in the file, one or more data formats or types of data in the file, etc. A content item may include, but are not limited to, a keyword, an image, a barcode, a quick response code, etc. In some embodiments, multiple header formats can exist for the source in the data acquisition system 102. In this scenario, the data acquisition system 102 can pick up the last header format that has been used for the source as a first try of header format matching.

In at least one embodiment, in an event that the matching module 224 fails to recognize or match the data based on this first header format, the matching module 224 can notify the user 118 or the relevant user and/or operator that is responsible for creating or revising the header formats. Additionally or alternatively, in an event that one or more additional header formats exists for this source, the matching module 224 can attempt to recognize or match the data of the file based on the one or more additional header formats one by one. The matching module 224 can stop matching the additional header formats if one of the additional header formats successfully matches the data of the file to obtain the header information or the matching module 224 has exhausted each of the one or more additional header formats. If the matching module 224 has exhausted each of the one or more additional header formats, the matching module 224 can notify the user 118 or the relevant user and/or operator that is responsible for creating or revising creating or revising the header formats for resolution.

The matching module 224 can fail to recognize or match the data of the file based on the header format due to one or more factors. For example, the matching module 224 can detect a presence of data inconsistency based on the header format. In at least one embodiment, the data inconsistency can include a presence of data in a position in the file (and/or a presence of additional data in the file) that is unexpected according to the header format. Additionally or alternatively, the matching module 224 can determine that the file at a position of the one or more positions specified in the header format does not include expected data or includes unexpected data. In some embodiments, in response to detecting a presence of data inconsistency, the matching module 224 can search the file to locate a content item (such as a keyword, bar code, or other embedded image within a document for example) associated with the position specified in the header format. If the matching module 224 still fails to find the content item in the file, the matching module 224 can determine that the current header format is incorrect for this file of the source, and can either notify the user 118 or the relevant user and/or operator, or select another header format (if an additional header format for this source that has not been tried exists).

Upon successfully finding a matching header format for the file, a validation module 226 can validate the header information determined or obtained by the matching module 224 against one or more validation rules (and/or the header format). The one or more validation rules can include, but are not limited to, a rule based on a type of the data and/or a rule based on a format of the data. In some embodiments, although the matching module 224 can successfully recognize or match the data of the file based on one or more positions and/or one or more content items specified in a header format, the validation module 226 can find or determine that the data fails to match a data format or type specified in the one or more validation rules (or the header format). In this case, the validation module 226 can notify the user 118, the relevant user and/or operator that is responsible for creating or revising creating or revising the header formats, or another relevant person who is responsible for validating header information of a file for resolution.

In an event that the validation module 226 successfully validates the data of the file against the one or more validation rules (and/or the header format), the matching module 224 can attempt to find a matching line item format (or pattern template) that can locate line items in the file. In at least one embodiment, the line items can include data values (such as cost, price, meter reading, etc.), data descriptions (e.g., item or product description, etc.), etc. Similar to the foregoing descriptions for a header format, the data acquisition system 102 can know or determine a line item format associated with the source in advance through human input or intervention, for example, from the user 118 or a relevant user and/or operator responsible for creating or revising line item formats (or pattern templates).

In at least one embodiment, the matching module 224 can attempt to match a line item format to the data of the file. In at least one embodiment, the line item format can include one or more (relative or absolute) positions of data expected to be found in a file within a predetermined threshold of error, one or more line items (and/or content items such as keywords, bar codes, other embedded images within a file or document, etc.) expected to be found in the file, one or more data formats or types of data in the file, etc. In some embodiments, multiple line item formats can exist for the source in the data acquisition system 102. In this scenario, the data acquisition system 102 can pick up the last line item format that has been used for the source as a first try of line item format matching.

In at least one embodiment, in an event that the matching module 224 fails to recognize or match the data based on this first line item format, the matching module 224 can notify the user 118 or the relevant user and/or operator that is responsible for creating or revising creating or revising the line item formats. Additionally or alternatively, in an event that one or more additional line item formats exists for this source, the matching module 224 can attempt to recognize or match the data of the file based on the one or more additional line item formats one by one. The matching module 224 can stop matching the additional line item formats if one of the additional line item formats successfully matches the data of the file to obtain the line item information or the matching module 224 has exhausted each of the one or more additional line item formats. If the matching module 224 has exhausted each of the one or more additional line item formats, the matching module 224 can notify the user 118 or the relevant user and/or operator that is responsible for creating or revising creating or revising the line item formats for resolution.

The matching module 224 can fail to recognize or match the data of the file based on the line item format due to one or more factors. For example, the matching module 224 can detect a presence of data inconsistency based on the line item format. In at least one embodiment, the data inconsistency can include a presence of data in a position in the file (and/or a presence of additional data in the file) that is unexpected according to the line item format. Additionally or alternatively, the matching module 224 can determine that the file at a position of the one or more positions specified in the line item format does not include expected data or includes unexpected data. In some embodiments, in response to detecting a presence of data inconsistency, the matching module 224 can search the file to locate a content item (such as a keyword, an image, a barcode, a quick response code or other embedded image, etc.) associated with the position specified in the header line item. If the matching module 224 still fails to find the content item in the file, the matching module 224 can determine that the current line item format is incorrect for this file of the source, and can either notify the user 118 or the relevant user and/or operator, or select another line item format (if an additional line item format for this source that has not been tried exists).

Upon successfully finding a matching line item format for the file, the validation module 226 can validate the line item information determined or obtained by the matching module 224 against one or more other validation rules (and/or the line item format). The one or more other validation rules can include, but are not limited to, a rule based on a type of the data and/or a rule based on a format of the data. In some embodiments, although the matching module 224 can successfully recognize or match the data of the file based on one or more positions and/or line items (and/or content items) specified in a line item format, the validation module 226 can find or determine that the data fails to match a data format or type specified in the one or more validation rules (or the line item format). In this case, the validation module 226 can notify the user 118, the relevant user and/or operator who is responsible for creating or revising creating or revising the line item formats, or another relevant person who is responsible for validating line item information of a file for resolution.

In at least one embodiment, upon successfully validating the line item information, the data acquisition system 102 or an extraction module 228 can extract the line item information from the file for storage in the form of a data structure. In at least one embodiment, the data structure can be varied or customized for different sources and/or different types of data of a same source. For example, data structures for different sources and/or different types (e.g., text, number, image, barcode, etc.) may be different. In some embodiments, the data structure can be the same or similar for a plurality of different sources having same or similar line item information to be extracted, for example. Regardless of what data structure is used for the extracted information, the data acquisition system 102 can cause the data structure to be stored locally, for example, in the program data 212 or in a database 230, and/or remotely, such as the client device 104 and/or the servers 106. For example, the output module 222 can cause the data acquisition system 102 to send the extracted information to the client device 104 and/or the one or more servers 106. Additionally, the data acquisition system 102 can cause the data structure to be stored in a portable or removable storage device so that the user 118 can process or store the extracted information via other computing devices such as a client device 104.

In some embodiments, the data acquisition system 102 can further include an anchor module 232. The anchor module 232 is configured to use one or more (internal) anchors that have been determined in advance for a template such as by the user 118 or other relevant user and/or operator. In at least one embodiment, the one or more anchors can include, for example, one or more pieces of the header information, one or more pieces of line item information, one or more pieces of content item information, and/or one or more corners of a page of the file, etc. This is because a page of a file that is received by the data acquisition system 102 can sometimes be misaligned, mis-oriented and/or scaled, shifted, etc.

In some instances, the page of the file can be occluded or blurred for some irrelevant parts. In either case, the matching module 224 can fail to recognize or match data of a file based on a pattern template (e.g., a header format or a line item format) even if the pattern template is the correct template for this file. In this case, the matching module 224 can request the anchor module 232 to locate one or more anchors for that file based on, for example, recognizing certain information in the file using object recognition. After locating the one or more anchors for that file, the anchor module 232 can, in at least one embodiment, rotate, scale and/or translate a page of the file to a predetermined configuration and notify the matching module 224 to perform matching the pattern template again for this file. Alternatively, the anchor module 232 can temporarily or internally create a modified pattern template for the pattern template currently used by the matching module 224 based on the one or more located anchors (i.e., rotating, scaling and/or translating the currently used pattern template). The matching module 224 can then attempt to recognize or match the data of the file using the modified pattern template. Additionally or alternatively, in at least one embodiment, the anchor module 232 may re-compute one or more expected positions or coordinates of data (e.g., header information, content items, line items, etc.) in a pattern template (that is currently used by the matching module 224) based on the one or more located anchors. The anchor module 232 may provide these re-computed positions to the matching module 232, which then recognizes or matches the data of the file based on the pattern template but with the re-computed positions.

### Illustrative Methods

FIGS. 3, 4, 5, 6, 7A, and 7B are flow diagrams depicting example processes for data acquisition. The operations of the example process is illustrated in individual blocks and summarized with reference to those blocks. The process is illustrated as logical flows of blocks, each block of which can represent one or more operations that can be implemented in hardware, software, or a combination thereof.

In the context of software, the operations represent computer-executable instructions stored on one or more computer-readable storage media that, when executed by one or more processors, enable the one or more processors to perform the recited operations. Generally, computer-executable instructions include routines, programs, objects, modules, components, data structures, and the like that perform particular functions or implement particular abstract data types. The process can also be practiced in a distributed computing environment where functions are performed by remote processing devices that are linked through a communication network. In a distributed computing environment, computer-executable instructions can be located in local and/or remote computer storage media, including memory storage devices.

In the context of hardware, some or all of the blocks can represent application specific integrated circuits (ASICs) or other physical components that perform the recited operations.

The order in which the operations are described is not intended to be construed as a limitation, and any number of the described operations can be executed in any order, combined in any order, subdivided into multiple sub-operations, and/or executed in parallel to implement the described process.

FIG. 3 is a flowchart overview of an example process 300 of data acquisition. FIG. 4 is a flowchart depicting an example process 400 of data acquisition consistent with FIG. 3 in more detail. FIG. 5 is a flowchart depicting a first example process 500 of data acquisition. FIG. 6 is a flowchart depicting a second example process 600 of data acquisition. FIG. 7A and FIG. 7B are flowcharts depicting aspects of data acquisition consistent with FIG. 6 in more detail. The processes of FIG. 3, FIG. 4, FIG. 5, FIG. 6, FIG. 7A and FIG. 7B can, but need not, be implemented in the environment of FIG. 1 and/or using the system of FIG. 2. For ease of explanation, processes 300, 400, 500 and 600 are described with reference to FIGS. 1 and 2. However, the any of these processes can alternatively be implemented in other environments and/or using other systems.

FIG. 3, at 300 represents an overview of an illustrative embodiment of data acquisition.

In the example shown at block 302, one or more documents, sometimes in a variety of formats are received as input.

At block 304 a data acquisition system (DAS) accepts the one or more documents from block 302.

At block 306 the data acquisition system (DAS) from block 304 produces output based on the one or more documents from block 302. In at least one embodiment, the data acquisition system produces output in a custom format.

FIG. 4 at 400 represents an illustrative embodiment of data acquisition consistent with FIG. 3 in more detail.

In the example shown at element 402, one or more files and/or documents, sometimes in a variety of formats are received as input. For example, at 402 the one or more documents can include a plurality of documents in various formats. Such document formats can include, but are not limited to, native digital documents (PDF), scanned digital documents (PDF), scanned images (PNG, JPG, BMP, etc), as well as other file or document types described herein.

Element 404 represents a data acquisition system (DAS) configured to accept the one or more files and/or documents from element 402 as input.

At element 406 the data acquisition system (DAS) from element 404 can produce output based on the one or more documents from element 402. In at least one embodiment, the data acquisition system produces output in a batch output file. In at least one embodiment, the data acquisition system produces output in a custom format. In either case, the output file can contain the data acquired for a vendor. In the batch case, the output file can contain the data acquired from all successfully translated documents during the interval between runs of the scheduler operating as a batch scheduler.

In various embodiments, element 404 includes a variety of sub elements.

At 408 a preparation action can be taken to prepare the file and/or document for translation. For example, for native PDFs, preparation can include extracting the textual data and its physical location in the file/document.

Element 410 represents a Document Data Acquisition Translator (DDAT) Manager, which in some embodiments, includes a software service that creates a list of files and/or documents that are ready for translation and handles distributing those documents to any connected DDAT applications.

Element 412 represents a single file or document that is ready for translation being distributed to a DDAT application 414.

Element 414 represents the DDAT application, which includes an application configured for pulling data from each file and/or document using data format maps, which can be stored in a database 416. Data format maps can be created using a process sometimes called data mapping. In various embodiments, data mapping is a manual or at least partially automated process of determining the specific elements of data to which each piece of data contained in a file and/or document corresponds.

Element 416 represents a database storing data format maps. In various embodiments, data format maps include format maps that define where specific pieces of data are located within a file and/or document. The DDAT can attempt to apply each format map associated with a source of the file or document to acquire all of the data from the file or document until a matching format map is applied or until the format maps associated with the source of the file or document are exhausted.

Element 418 represents a determination of whether the DDAT successfully acquired all of the data from the file or document using the data format maps stored in database 416. In the event that the DDAT did not successfully acquire all of the data from the file or document using the data format maps stored in database 416, at 418 a decision is made regarding whether the failure is due to a map-level error or a failure due to another reason. In the event the failure is due to a map-level error, the file or document that failed is passed to a data mapping operator 420. In the event the failure is due to another reason, the file or document that failed is passed to a data entry operator 422. In the event that the DDAT did successfully acquire all of the data from the file or document using the data format maps stored in database 416, at 418 a decision is made to pass the acquired data to temporary data storage 424.

Element 420 represents a data mapping operator, which in some embodiments includes a human performing at least part of a map creation process. In various embodiments, the map creation process is a manual or at least partially automated process of generating a new or updated map for data mapping based on data from a document that was not automatically picked up by the DDAT.

In various embodiments, the operator represented by element 420 causes the new or updated map to be saved as a fresh map in database 416. In at least one embodiment the fresh map does not replace any existing maps in database 416. Since the DDAT has not yet acquired all of the data from the file or document that caused the creation of the fresh map, the DDAT will attempt to pull data from the file or document that caused the creation of the fresh map by applying the fresh map stored in database 416.

Element 422 represents a data entry operator, which in some embodiments includes a human who, in an event that an automated process of data mapping is not fully successful for a particular file or document, performs a manual process of keying data from a document that was not automatically picked up by the DDAT.

In various embodiments, the operator represented by element 422 causes the data acquired manually and/or via an automated process to be passed to temporary data storage 424.

Element 424 represents temporary data storage, which in various embodiments includes a file server configured to store the temporary data that has been acquired from each document.

Element 426 represents a scheduler configured to combine all translated data from the temporary data storage 424 into an output file based on output format options stored in database 428. In various embodiments, the scheduler represents a batch scheduler that combines all translated data from the temporary data storage 424 into a single batch output file based on output format options stored in database 428 according to a programmable schedule.

Element 428 represents a database storing output format options. In various embodiments, output format options specify one or more custom output formats for the acquired data according to the customer for the data, which in some instances includes the source of the data. In various embodiments, the scheduler provides output data in a custom format according to the output format options stored in database 428.

Example operations of a data acquisition system, such as data acquisition system 102 are shown in FIG. 5, at 500. At block 502, the data acquisition system 102 receives a file.

At block 504, the data acquisition system 102 determines a source of the file. The data acquisition system 102 can determine the source of the file based on a user input or automatically based on content or data included in the file.

At block 506, the data acquisition system 102 determines a file type of the file. In at least one embodiment, the data acquisition system 102 can determine the file type of the file based on an extension of a filename of the file.

At block 508, the data acquisition system 102 selects an application to access or read the file based on the file type. In at least one embodiment, the data acquisition system 102 can include a list of applications for each accepted file type, and can further set one of the applications as a default application for each file type.

At block 510, the data acquisition system 102 attempts to recognize data in the file based on a pattern template associated with the source. The pattern template can include specification or information of one or more expected positions of the data in the document within a predetermined threshold of error. Additionally or alternatively, the pattern template can include specification or information of one or more expected formats of the data in the file. Additionally or alternatively, the pattern template can include one or more keywords expected to be found in the file. In at least one embodiment, the data acquisition system 102 can determine whether the data exists at the one or more positions and/or the data includes the one or more keywords.

At block 512, in an event that the data acquisition system 102 locates the one or more positions and/or the one or more keywords in the document based on the pattern template, the data acquisition system 102 can extract the data from the file.

At block 514, the data acquisition system 102 can detect a presence of data inconsistency based on the pattern template. In at least one embodiment, the data inconsistency can include a presence of data in a position in the file (and/or a presence of additional data in the file) that is unexpected according to the pattern template. Additionally or alternatively, determines that the file at a position of the one or more positions specified in the pattern template does not include expected data or includes unexpected data.

At block 516, in response to detecting a presence of data inconsistency, in at least one embodiment, the data acquisition system 102 can search the file to locate a keyword associated with the position specified in the pattern template.

At block 518, if the data acquisition system 102 finds the keyword at a new position, the data acquisition system 102 can recognize associated data at the new position that is associated with the keyword in the file. Additionally, in some embodiments, the data acquisition system 102 can further notify the user 118 of this change in data template of the file so that the user 118 can determine whether a new pattern template is to be added. In some embodiments, the data acquisition system 102 can automatically record and store this change to create a new pattern template and use this new pattern template for a next file associated with the same source.

At block 520, if the data acquisition system 102 fails to recognize the data in the file (e.g., failing to find data at the one or more expected positions and failing to locate the one or more expected keywords in the file, etc.), the data acquisition system 102 can determine whether another pattern template associated with the source can exist. In an event that another pattern template exists for the source, the data acquisition system 102 can retrieve the other pattern template and perform the above operations based on the other pattern template.

At block 522, if no pattern template exists for the source or if the data acquisition system 102 has exhausted each pattern template of the source for recognizing the data of the file and fails, the data acquisition system 102 can notify the user 118 or a relevant user and/or operator responsible for creating or revising pattern templates for data recognition.

At block 524, the data acquisition system 102 receives a new pattern template for this source from the user 118 or the relevant user and/or operator. The data acquisition system 102 can then repeat the above operations to extract the data from the file.

At block 526, after extracting the data from the file, the data acquisition system 102 validates the extracted based on one or more validation rules. The one or more validation rules can include, for example, a rule based on a type of the data and/or a rule based on a format of the data.

At block 528, if the extracted data fails to pass a validation rule, the data acquisition system 102 can notify the user 118 or a relevant user and/or operator responsible for data validation for resolution.

At block 530, if the extracted data passes the one or more validation rules, the data acquisition system 102 can store the extracted data in a customized data format or structure. In at least one embodiment, the customized data format or structure can be specified for each source or can be generic for a plurality of sources (which can be some or all of the sources that are handled by the data acquisition system 102).

At block 532, the data acquisition system 102 can send the extracted data to a local storage and/or send the extracted data to the source or a third party such as a data aggregator.

The data acquisition system 102 can repeat one or more of the above operations for additional files.

Example operations of a data acquisition system, such as data acquisition system 102, are shown in FIG. 6, at 600. In the illustrated example, the data acquisition system has some connection to a data manager, which in some embodiments includes a document data acquisition translator (DDAT) manager.

At block 602, the data acquisition system receives a document or file.

At block 604, the data acquisition system identifies a source, such as a vendor, of the document.

At block 606, the data acquisition system determines whether the source of the document is identified. If unidentified, the data acquisition system produces a notification, such as a notification for a human data operator, which in some instances can be the user 118 or another person responsible for identifying or determining a source of a document for resolution.

At block 608, responsive to the data acquisition system successfully identifying or determining the source of the document from 406, the data acquisition system can attempt to identify source account information such as vendor account information.

At block 610, the data acquisition system determines whether account information of (or assigned to) the source is identified. If no account information is identified, the data acquisition system produces a notification, such as a notification for a human data operator, which in some instances can be the user 118 or another person responsible for assigning or identifying account information for resolution.

At block 612, responsive to the account information of the source being identified, the data acquisition system can attempt to find a matching header format (or pattern template) for this file. In at least one embodiment, the source can include one or more header formats for a same type of document or different types of document.

At block 614, the data acquisition system determines whether a matching header format (or pattern template) is found. If no matching header format (or pattern template) is found, the data acquisition system produces a notification, such as a notification for a human data operator, which in some instances can be the user 118 or another person responsible for creating or revising header formats for resolution.

At block 616, in response to finding a matching header format, the data acquisition system can validate the header information against one or more validation rules (which can include, for example, data format and/or data type associated with the header information, etc.). In some instances, the data acquisition system can extract header information from the file in order to perform validation.

At block 618, the data acquisition system determines whether the header information passes a validation rule. If the header information fails to pass a validation rule, the data acquisition system produces a notification, such as a notification for a human data operator, which in some instances can be the user 118 or another person responsible for validating header information for resolution.

At block 620, responsive to successfully validating the header information, the data acquisition system can attempt to find a matching line item format (or pattern template) for this file.

At block 622, the data acquisition system determines whether a matching line item format is found. If no matching line item format is found, the data acquisition system produces a notification, such as a notification for a human data operator, which in some instances can be the user 118 or another person responsible for creating or revising line item formats for resolution.

At block 624, in response to finding a matching line item format, the data acquisition system validate the line item information against one or more other validation rules (which can include, for example, data format and/or data type associated with the line item information, etc.). In some instances, the data acquisition system can extract line item information from the file in order to perform validation.

At block 626, the data acquisition system determines whether the line item information passes a validation rule. If the line item information fails to pass a validation rule, the data acquisition system produces a notification, such as a notification for a human data operator, which in some instances can be the user 118 or another person responsible for validating line item information for resolution.

At block 628, upon successfully validating the line item information, the data acquisition system can acquire data from the document using matching formats. In some embodiments, the data acquisition system can store the line item information in a customized data format or structure.

At block 630, the data acquisition system can produce document data as output. In various embodiments, the acquisition system can store the output locally and/or send the output to the source or a third party such as a data aggregator.

Responsive to receiving an additional document, the data acquisition system can repeat one or more of the above operations for this additional document.

Example operations of a data acquisition system, such as data acquisition system 102, attempting to find a matching header format 612 and attempting to find a matching line item format 620 are shown in FIGS. 7A and 7B, respectively.

In the illustrated example 612, at block 702 the data acquisition system can apply a most recently used header format for the identified vendor.

At block 704, the data acquisition system applies the template in use to look for each of the mapped pieces of data in this format. In at least one embodiment, the source can include one or more header formats for a same type of document or different types of document.

At block 706, the data acquisition system determines whether all of the mapped pieces of data in the header have been found. If all of the mapped pieces of data in the header have been found, the data acquisition system returns the data flow to block 614.

At block 708, if there are additional mapped pieces of data in the header, the data acquisition system applies another header format from the same vendor.

In the illustrated example 620, at block 710 the data acquisition system can apply a most recently used line item format for the identified vendor.

At block 712, the data acquisition system applies the template in use to look for each of the mapped pieces of data in this format. In at least one embodiment, the source can include one or more line item formats for a same type of document or different types of document.

At block 714, the data acquisition system determines whether all of the mapped pieces of data in the line item have been found. If all of the mapped pieces of data in the line item have been found, the data acquisition system returns the data flow to block 622.

At block 716, if there are additional mapped pieces of data in the line item, the data acquisition system applies another line item format from the same vendor.

Any of the acts of any of the processes described herein can be implemented at least partially by a processor or other electronic device based on instructions stored on one or more computer-readable media. By way of example and not limitation, any of the acts of any of the methods described herein can be implemented under control of one or more processors configured with executable instructions that can be stored on one or more computer-readable media such as one or more computer storage media.

### Illustrative Graphical User Interface

FIGS. 8, 9, 10, 11, 12, 13, and 14 are illustrative screen renderings depicting example processes for creating a pattern template for a Data Acquisition System (DAS) tool such as a Document Data Acquisition Translator (DDAT) consistent with one or more of the processes described above. In various embodiments, the pattern template can be created by a human data operator, which in some instances can be a user such as user 118 or another person responsible for data input. In alternate embodiments, the pattern template can be created by a processor or other electronic device based on instructions stored on one or more computer-readable media. The order in which the operations are described is not intended to be construed as a limitation, and any number of the described operations can be executed in any order, combined in any order, subdivided into multiple sub-operations, and/or executed in parallel to implement the described process.

FIG. 8 to FIG. 14 illustrate screen renderings of an example Graphical User Interface (GUI) on an electronic computing device which provides an easy-to-use interactive interface for the creation of a pattern template, the pattern template being associated with a file and/or document such as an invoice, a payment receipt, a purchase order, a utility bill, etc. used by a source (e.g., a vendor, other types of entities could include a service provider, a retailer, a wholesaler, a utility service provider, etc.), and comprising at least three areas. In various embodiments the three areas include a header, a line item and/or a detail. In some embodiments, the file and/or document can have file a type (or format) that can include, but is not limited to, a scanned file type or format, an image file type or format, etc. The image file type or format can include JPEG (Joint Photographic Experts Group), Exif (Exchangeable Image File Format), TIFF (Tagged Image File Format), RAW (Raw Image Format), GIF (Graphics Interchange Format), BMP (Bitmap), PNG (Portable Network Graphics), PPM (Portable Pixmap), PGM (Portable Graymap), PBM (Portable Bitmap), etc. Additionally or alternatively, the file type (or format) can include, a text (TXT) file type or format (e.g., a Word® format, a TXT format, an RTF format, a .doc format, a .docx format, etc.), a portable file type or format such as a native PDF (Portable Document Format) file type, a PS (PostScript) file type, etc. Additionally or alternatively, the file type (or format) can include a markup language format such as a Web file format (e.g., HTTP (Hypertext Transfer Protocol), XML (Extensible Markup Language)), to name to few. Additionally or alternatively, the file type (or format) can include a delimiter-separated values (DSV) file type a comma-separated values (CSV) file type, or a tab-separated values (TSV) file type, etc. Additionally or alternatively, the file type (or format) can include a quick-response code (QR Code) or a bar code, etc. In some embodiments, the file type (or format) can include a combination of the aforementioned file types (or formats) such as a PDF file with an embedded QR Code.

FIG. 8 illustrates a screen rendering of an example GUI on an electronic computing device, which allows a user of the device to initiate the selection of a source such as a vendor associated with a file and/or document such as an invoice. Responsive to user interaction, a particular vendor can be selected from a vendor selection menu 802. In some embodiments, GUI can comprise an interactive field, a pull-down list, and/or buttons operated by the user to enable the input of a new vendor.

In various embodiments, the GUI comprises a plurality of tabs 804 comprising data associated with the vendor. Responsive to vendor selection, the plurality of tabs 804 contain data associated with the vendor. The plurality of tabs 804 can include, but are not limited to, general information, financial information, services information, data definitions, and/or contact information. The plurality of tabs 804 can allow the user to navigate to different screens, the different screens having interactive and/or non-interactive fields.

FIGS. 9 and 10 illustrate a screen rendering of an example data definitions tab after a vendor has been selected. FIG. 9 illustrates the selection of data definitions. Meanwhile, FIG. 10 illustrates a display of selected data elements. In some embodiments, data elements become part of a pattern template. The GUI can contain a data definitions tab 902, the data definitions tab 902 displaying various data fields, including but not limited to a data definitions field 904, and a data elements field 906.

In some embodiments, the data definitions tab 902 includes a selection button to the data elements field 908 and a selection button to the data definitions field 910. The data definitions field 904 can comprise at least one of a plurality of data definitions associated with the vendor which can be processed by a pattern template.

In various embodiments, the data definitions tab 902 is interactive. In an interactive embodiment, the data definitions tab 902 enables the selection of at least one of a plurality of data definitions for processing. To select at least one of a plurality of data definitions for processing, in a manual process, a user highlights the desired at least one of a plurality of data definitions in the data definitions field 904 and presses the selection button to the data elements field 908, and in an automated process, a program module highlights the desired at least one of the plurality of data definitions and activates selection. Responsive to the selection activation to the data elements field, the selected at least one of at least one of a plurality of data definitions becomes at least one data element, the at least one data element being displayed in the data element field 906. The user or program module can also highlight at least one data element being displayed in the data element field 906 and activate the selection, such as the selection button to the data definitions field 910.

For example, if user decides that it does not want a late fee to be at least one data element, the user can highlight all data definitions in the data definitions field 904 except the late fee data definition, and press the selection button to the data elements field 908. Alternatively, if user transitions all data descriptions into data elements of the pattern template and later decides to exclude late fees, the user can simply highlight late fees in the data elements field 906 and press the selection button to the data definitions field 910, thereby turning the late fee data element back into a data definition.

In alternate embodiments, the data definitions tab 902 is non-interactive. In a non-interactive embodiment, the at least one of a plurality of data definitions are pre-determined for a vendor. In embodiments with pre-determined data definitions, the data definitions are also data elements, and can become part of the pattern template. In some embodiments, the GUI can comprise one or more interactive fields, a pull-down list, and/or buttons operated by the user to enable the input of a new data definition.

FIG. 10 illustrates a display of selected data elements. In the illustrative example of screen rendering 1000, a user has highlighted a plurality of data definitions, and pressed the selection button to the data elements field 908. In such an embodiment, the data definitions become data elements and are displayed in the data elements field 906.

FIG. 11 illustrates a screen rendering of an example GUI on an electronic computing device, which allows a user of the device to create a header of a pattern template, the pattern template associated with a source such as a vendor. In various embodiments, the header refers to one or more pieces of information included in the file and/or document 1102 that represent or characterize a file or data template of the source. The header format may include one or more (relative or absolute) positions of data expected to be found in a file and/or document 1102 within a predetermined threshold of error, one or more keywords expected to be found in the file and/or document 1102, one or more data formats or types of data in the file and/or document 1102, etc. In some embodiments, multiple header formats may exist for the source in the data acquisition system.

As depicted in screen rendering 1100, the interactive display for creating a header of a pattern template comprises a plurality of displays 1104 having interactive fields, pull-down lists, and/or buttons operated by the user. The plurality of displays 1104 can include, but are not limited to, vendor data, format data, box alignment, data elements, element types, currency symbols, number formats, and negative symbols. In some embodiments, the GUI comprises a plurality of tabs for ease of transition between pattern template elements including, but not limited to a header tab 1106 and a line item tab.

The header tab 1106 displays information associated with a source such as a vendor, the information to be mapped to the header. In various embodiments, the header tab 1106 is an interactive tab which works in conjunction with the file and/or document to create a header. The header tab 1106 contains interactive fields including, but not limited to, a box alignment field, a data element field, an element type field, a currency symbol field, a number format field, and a negative symbol field.

In various embodiments, the creation of the header of a pattern template comprises associating each of a plurality of units of data on a file and/or document 1102 such as an invoice with a data element, an alignment, a data element type, at least one symbol, and at least one number format. In some embodiments, the plurality of units of data can include data common to all invoices derived from a vendor. The association can be done by at least one of the following steps: selecting a data element, selecting alignment, selecting data element type, selecting currency symbol, selecting number format, selecting negative symbol, highlighting at least one of a plurality of data on the representation of the file and/or document, the data represented on the file and/or document corresponding to the data element and the data element type, and selecting a mapping button, the mapping button tying all steps together.

In various embodiments, selecting alignment includes a left alignment, a right alignment, and an exact alignment. The left alignment and the right alignment can read data from the left and the right edge of the representation of the file and/or document, respectively. The exact alignment can read data at the exact data location.

In some embodiments, selecting element type includes, but is not limited to selecting general text, alphanumeric, numeric, currency, date, URL, email address, phone number, or any other appropriate element type.

FIG. 12 illustrates an example GUI that displays an interactive invoice, after creating a header of a pattern template, the pattern template associated with a vendor. In various embodiments, the header is created when each of a plurality of units of data on a representation of a file and/or document is associated with a data element, an alignment, a data element type, at least one symbol, and at least one number format. The association can be verified by each of the plurality of units of data on the representation of the file and/or document changing color. For example, verified data on the representation of the file and/or document can be green, while unverified data can be orange colors. In the same illustrative example, the element data of customer address, customer city and customer name, have been verified and the corresponding data on the representation of the file and/or document are green.

FIG. 13 illustrates a screen rendering of an example GUI on an electronic computing device, which allows a user of the device to create a line item of a pattern template, the line item associated with a header, and the pattern template associated with a source such as a vendor. In some embodiments, the line items can include data values (such as cost, price, meter reading, etc.), data descriptions (e.g., item or product description, etc.), etc. In various embodiments, the interactive display for creating a line item of a pattern template comprises a plurality of displays having interactive fields, pull-down lists, and/or buttons operated by the user. The plurality of displays can include, but are not limited to, vendor data, format data, service data, line item data, entire or subcomponent selection, alignment data, and element types. In various embodiments, the line item can be created by selecting a line item tab 1302 from a plurality of tabs including, but not limited to a header tab and a line item tab.

In various embodiments, the creation of a line item of a pattern template comprises associating each of a plurality of units of data on a representation of a file and/or document with a format data, service data, line item data, entire or subcomponent selection, alignment data, and element types. The association can be done by at least one of the following steps: selecting data from the invoice, selecting a data element, selecting entire or subcomponent, selecting alignment, selecting data element type, and selecting a mapping button, the mapping button tying all steps together.

In various embodiments, a line item can be linked to a customer of the vendor. In an illustrative example, a line item can be used for a utility company. In such an example, the line item can comprise at least one of a plurality of items including but not limited to a start date, an end date, a billed demand, a use, and a billed use.

In some embodiments, the user can create a new name for the line item by selecting the line item in the format field 1304. Upon selection of the line item, the user can click on the option to rename the line item. Additionally, the user can create a new line item by selecting an add new line item button 1306. Responsive to user selecting the add new line item button 1306, a new format box 1308 displays on the screen, the new format box being associated with the vendor. In various embodiments, user can selectively input a new name for the new line item and/or a description of the new line item in new format box 1308.

FIG. 14 illustrates a screen rendering of an example GUI on an electronic computing device, which allows a user of the device to create a detail of a pattern template, the detail associated with a line item, and the pattern template associated with a source such as a vendor. In various embodiments, the interactive display for creating a detail of a pattern template comprises a plurality of displays having interactive fields, pull-down lists, and/or buttons operated by the user. In some embodiments, the detail can be created by selecting a line item tab 1402 from a plurality of tabs including, but not limited to a header tab and a line item tab. In an alternate embodiment, the detail can be created by selecting a detail tab from a plurality of tabs including, but not limited to a header tab, a line item tab, and a detail tab.

The interactive display on the line item tab 1402 can include a plurality of menus including, but not limited to, service data, line item data, and new detail data. In various embodiments, the detail is created by at least one of the following steps: selecting a line item, selecting at least one data on an invoice, selecting entire or subcomponent, selecting data element type, selecting alignment, and selecting add new detail.

In various embodiments, the detail is created by selecting a subcomponent, causing the detail to only save a title. In another embodiment, the detail is created by selecting an entire element, causing the entire element to be saved as a detail.

In an illustrative example, a detail can be applied for a utility company. In such an example, the detail can comprise at least one of a plurality of items including, but not limited to, a rate, a meter charge, a fire charge, or any other appropriate details associated with a line item.

FIGS. 15, 16, 17, and 18 illustrate an example Graphical User Interface (GUI) that provide an easy-to-use interactive interface on an electronic computing device to initiate or to represent data translation. In various embodiments, data translation can be executed a human data operator, which in some instances can be a user such as user 118 or another person responsible for data input. In alternate embodiments, data translation can be executed by a processor or other electronic device based on instructions stored on one or more computer-readable media. The electronic computing device such as device 104 can include any type of electronic computing device with one or multiple processor(s) such as multiple processor(s) 110 operably connected to a memory such as memory 112. The electronic computing device can include personal computers such as, for example, desktop computers, laptop computers, tablet computers, telecommunication devices, personal digital assistants (PDAs), electronic book readers, wearable computers. The electronic computing device can also include business oriented devices such as, for example, server computers, thin clients, terminals, and/or work stations. In some embodiments, the electronic computing device can include, for example, components for integration in a computing device, appliances, or another sort of device.

In various embodiments, GUI can include a stand-alone electronic computing device, or it can be incorporated into a web interface, the web interface being available on at least one of a plurality of networks. The plurality of networks can be a collection of individual networks interconnected with each other and functioning as a single large network (e.g. the Internet or an intranet). Examples of such networks include, but are not limited to, telephone networks, cable networks, Local Area Networks (LANs), Wide Area Networks (WANs), and Metropolitan Area Networks (MANs), Wi-Fi networks, WiMax networks, satellite networks, mobile communications networks (e.g., 3G, 4G, and so forth), or any combination thereof. In various embodiments, data translation can include an upload stage, a translation stage, and/or a compilation stage. In some embodiments, GUI comprises a plurality of displays having interactive fields, pull-down lists, and/or buttons operated by the user. In some embodiments, GUI comprises a plurality of tabs for ease of transition between stages.

FIG. 15 illustrates a screen rendering of an example GUI on an electronic computing device. In various embodiments, the GUI comprises a plurality of displays having interactive fields, pull-down lists, and/or buttons operated by the user. In some embodiments, such as depicted in screen rendering 1500, a user may select from a plurality of tabs including, but not limited to an upload tab, a translation tab, a translation statistics tab, and a billing tab. The plurality of tabs can allow the user to navigate to different screens, the different screens displaying information at each stage of the data translation. For example, the upload tab can enable a user to browse via a browse button 1502 and select at least one of a plurality of files and/or documents to upload. A browse field 1504 can permit the user to input a query for data associated with at least one source such as a vendor. In various embodiments, the query can be to a single or a plurality of computing devices, such as those connected via a wide-area network (WAN), a local-area network (LAN), and/or an Internet.

In some embodiments, the plurality of files and/or documents can include files and/or documents having a file a type (or format) that can include, but is not limited to, a scanned file type or format, an image file type or format, etc. The image file type or format can include JPEG (Joint Photographic Experts Group), Exif (Exchangeable Image File Format), TIFF (Tagged Image File Format), RAW (Raw Image Format), GIF (Graphics Interchange Format), BMP (Bitmap), PNG (Portable Network Graphics), PPM (Portable Pixmap), PGM (Portable Graymap), PBM (Portable Bitmap), etc. Additionally or alternatively, the file type (or format) can include, a text (TXT) file type or format (e.g., a Word® format, a TXT format, an RTF format, a .doc format, a .docx format, etc.), a portable file type or format such as a native PDF (Portable Document Format) file type, a PS (PostScript) file type, etc. Additionally or alternatively, the file type (or format) can include a markup language format such as a Web file format (e.g., HTTP (Hypertext Transfer Protocol), XML (Extensible Markup Language)), to name to few. Additionally or alternatively, the file type (or format) can include a delimiter-separated values (DSV) file type a comma-separated values (CSV) file type, or a tab-separated values (TSV) file type, etc.

FIG. 16 illustrates a screen rendering of an example GUI on an electronic computing device after a user has selected a browse button such as browse button 1502. The browse button such as browse button 1502 can cause an upload box 1602 to display on the interactive screen. In various embodiments, the upload box 1602 allows user to select at least one of a plurality of files and/or documents to upload.

Responsive to user selecting at least one of a plurality of files and/or documents to upload in the upload box 1602, the electronic computing device processes the plurality of files and/or documents selected, and runs a translation. In some embodiments, the translation can include setting an anchor, determining whether data exists relative to the anchor, and extracting information from each of the at least one of the plurality of files and/or documents.

FIG. 17 illustrates a screen rendering of an example GUI on an electronic computing device after a user has selected files and/or documents to upload. The GUI as depicted in screen rendering 1700 illustrates an upload tab. In various embodiments, the upload tab can include a screen, the screen enabled to display each of a plurality of steps during the translation.

FIG. 18 illustrates a screen rendering of an example GUI on an electronic computing device after a user has selected files and/or documents to upload and the user has selected a translation tab 1802. In some embodiments, the translation tab enables user to track progress of the translation of each of the at least one of the plurality of files and/or documents. The translation tab can include a plurality of displays having interactive fields including, but not limited to, a status, a file name, a view file type, and a view output. The view output enables the user to access the information from each of the at least one of the plurality of files and/or documents, the information being unified and normalized into a spreadsheet.

In various embodiments, the GUI includes a translation statistics tab 1804 and a billing tab 1806. The translation statistics tab 1804 can include a compilation of a plurality of statistics specific to a vendor. The GUI can also include a billing tab 1806 that navigates billing activity specific to a vendor. The GUI can enable a user to select the vendor, and view the compilation of a plurality of statistics and the billing activity associated with that vendor. In some embodiments, the compilation of a plurality of statistics and the billing activity cannot be vendor specific.

Any of the acts of any of the processes described herein can be implemented at least partially by a processor or other electronic device based on instructions stored on one or more computer-readable media. By way of example and not limitation, any of the acts of any of the methods described herein can be implemented under control of one or more processors configured with executable instructions that can be stored on one or more computer-readable media such as one or more computer storage media as otherwise described herein.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

In some embodiments, one or more of the methods and processes described above can be embodied in, and fully automated via, software code modules executed by one or more computers or processors such as computers or processors including device(s) 104 and/or server(s) 106. The code modules can be stored in any type of computer-readable storage medium or other computer storage device. Some or all of the methods can alternatively be embodied in specialized computer hardware.

Conditional language such as, among others, “can,” “could,” “might” or “may,” unless specifically stated otherwise, are otherwise understood within the context as used in general to present that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Conjunctive language such as the phrase “at least one of X, Y or Z,” unless specifically stated otherwise, is to be understood to present that an item, term, etc. can be either X, Y, or Z, or a combination thereof.

Any routine descriptions, elements or blocks in the flow diagrams described herein and/or depicted in the attached figures should be understood as potentially representing modules, segments, or portions of code that include one or more executable instructions for implementing specific logical functions or elements in the routine. Alternate implementations are included within the scope of the embodiments described herein in which elements or functions can be deleted, or executed out of order from that shown or discussed, including substantially synchronously or in reverse order, depending on the functionality involved as would be understood by those skilled in the art.

It should be emphasized that many variations and modifications can be made to the above-described embodiments, the elements of which are to be understood as being among other acceptable examples. All such modifications and variations are intended to be included herein within the scope of this disclosure and protected by the following claims.

1. A method comprising:
under control of one or more processors configured with executable instructions for document data acquisition:
receiving a document, the document being an electronic document or non-electronic document;
responsive to receiving a non-electronic document, converting the non-electronic document to an electronic document;
determining a file type of the electronic document;
selecting an application to access the electronic document based at least on the file type;
determining, from a plurality of sources providing one or more documents, a source of the electronic document, the determining based at least in part on recognizing one or more pieces of information identifying the source, wherein the information is included in the electronic document; and
recognizing, based at least on the determining the source, data in the electronic document based at least on a plurality of pattern templates associated with the source.

2. A method as claim 1 recites, wherein recognizing the data comprises:
locating one or more positions and/or one or more content items in the electronic document based at least on the plurality of pattern templates; and
extracting the data from the electronic document based at least on the locating.

3. A method as claim 2 recites, wherein prior to extracting the data, the method further comprises:
determining whether the data exists at the one or more positions and/or the data includes the one or more content items; and
in response to determining that the data exists at the one or more positions and/or the data includes the one or more content items, extracting the data from the electronic document.

4. A method as claim 1 recites, wherein the file type comprises an image file type, a scanned file type, a native portable document format (PDF) file type, a non-native PDF file type, an Extensible Metadata Language (XML) file type, a comma separated values (CSV) file type, or a text file type.

5. A method as claim 1 recites, further comprising:
detecting a presence of data inconsistency based at least on one or more of the plurality of pattern templates; and
in response to detecting the presence of the data inconsistency, sending the electronic document to a device for presentation to a user for resolution.

6. A method as claim 5 recites, further comprising:
receiving a new pattern template from the user; and
recognizing the data in the electronic document based at least on the new pattern template.

7. A method as claim 5 recites, wherein the data inconsistency comprises:
a presence of data in a position within the electronic document that is unexpected according to the one or more of the plurality of pattern templates; or
a presence of additional data in the electronic document that is unexpected according to the one or more of the plurality of pattern templates.

8. (canceled)

9. A method as claim 1 recites, further comprising: validating the data according to one or more validation rules.

10. A method as claim 9 recites, wherein the one or more validation rules comprises a rule based at least on a type of the data and/or a rule based at least on a format of the data.

11. A method as claim 1 recites, wherein a pattern template of the plurality of pattern templates comprises one or more expected positions of the data in the electronic document within a predetermined threshold of error or one or more expected formats of the data in the document.

12. A method as claim 1 recites, wherein a data structure of the plurality of pattern templates is different from a data structure of a plurality of pattern templates associated with another source.

13. One or more storage media storing executable instructions that, when executed by one or more processors, cause the one or more processors to perform acts comprising:
determining, from a plurality of sources providing one or more files, a source of a file, the determining based at least in part on recognizing one or more pieces of information identifying the source wherein the information is included in the file;
recognizing, responsive to determining the source of the file, data in a file based at least on a plurality of pattern templates associated with the source of the file, one or more pattern templates of the plurality of pattern templates specifying one or more positions of the data expected to be found within a predetermined threshold of error; and
determining whether the file at any of the one or more positions specified in the one or more pattern templates does not include expected data or includes unexpected data.

14. The one or more storage media as claim 13 recites, the acts further comprising:
responsive to determining that the file at a position of the one or more positions specified in the one or more pattern templates does not include expected data or includes unexpected data, searching the file to locate a content item associated with the position specified in the one or more pattern templates; and
recognizing data at a new position associated with the content item in the file.

15. The one or more storage media as claim 13 recites, the acts further comprising:
responsive to determining that the file at a position of the one or more positions specified in the one or more pattern templates does not include expected data or includes unexpected data, determining whether another pattern template of the one or more pattern templates is available; and
in response to determining that another pattern template of the one or more pattern templates is available, recognizing the data in the file based at least on the another pattern template.

16. The one or more storage media as claim 13 recites, the acts further comprising:
responsive to determining that the file at a position of the one or more positions specified in the one or more pattern templates does not include expected data or includes unexpected data, determining whether another pattern template of the one or more pattern templates is available; and
in response to determining that no other pattern template of the one or more pattern templates, sending the file to a device for presentation to an operator for resolution.

17. The one or more storage media as claim 16 recites, the acts further comprising:
receiving a new pattern template from the operator; and
recognizing the data in the file based at least on the new pattern template.

18. The one or more storage media as claim 13 recites, the acts further comprising: in response to determining that the positions of the data in the file match the one or more positions specified in the one or more pattern templates, extracting the data at the one or more positions specified in the one or more pattern templates.

19. A graphical user interface comprising:
a document data acquisition tool;
an area from which to identify a source of a document from a plurality of sources providing one or more documents;
an area in which to display the document, the document being associated with the source;
an area from which to select at least one of a plurality of data elements, wherein the plurality of data elements are associated with the source;
an area from which to select at least one of a plurality of line items, wherein the at least one of a plurality of line items is associated with the source; and
an area from which to select at least one of a plurality of details, wherein the at least one of a plurality of details is associated with the at least one of a plurality of line items.

20. A graphical user interface as claim 19 recites, wherein the document further comprises at least one of an image file type, a scanned file type, a native portable document format (PDF) file type, a non-native PDF file type, an Extensible Metadata Language (XML) file type, a comma separated values (CSV) file type, or a text file type.

21. A graphical user interface as claim 19 recites, wherein the document is uploadable via a web accessible interface.

22. A graphical user interface as claim 19 recites, wherein the area from which to select at least one of a plurality of line items further comprises an interactive field, wherein the interactive field enables a user to create a new line item.

23. A graphical user interface as claim 19 recites, wherein the graphical user interface, responsive to the selection of at least one of the plurality of data elements, at least one of the plurality of line items, and/or at least one of the plurality of details, creates and saves a pattern template associated with the source.

24. The one or more storage media as claim 13 recites, wherein recognizing data in the file further comprises recognizing data in the file based at least on locating one or more predetermined internal anchors, wherein the one or more predetermined internal anchors are used as reference points to rotate, scale, and/or translate a file to a predetermined configuration.
